(19) United States
(12) Patent Application Publication
(10) Pub. No.: US 2004/0161213 A1
(43) Pub. Date: Aug. 19, 2004

(54) Fiber optic display device

(76) Inventor: Tsung-Ting Lee, Chia-Yi Hsien (TW)

Correspondence Address: SUPREME PATENT SERVICES, POST OFFICE BOX 2339, SARATOGA, CA, 95070, US

(21) Appl. No.: 10/368,212

(22) Filed: Feb. 15, 2003

(51) Int. Cl. G02B 6/04

(52) U.S. Cl. 385/120; 385/121

(57) ABSTRACT

A fiber optic display device includes a linear array of illuminating elements, such as ultraviolet light emitting diodes, selectively emitting and projecting a first light onto a reflective surface of a rotary scanner that is rotated by a motor to have the reflective surface move the projected light over a light receiving surface of a light collector. The light collector receives the projected light and transmits the light through an array of optic fibers to a screen panel. The light is converted by a fluorescent layer of the screen panel into a visible light and forms an image.

### FIELD OF THE INVENTION

The invention relates to a display device, and in particular to a display device comprising optic fibers for transmission of optic signals in operating the display device. The invention also relates to a method of operating the optic fiber display device.

### BACKGROUND OF THE INVENTION

Generally, the display products available in the market may be divided into four types: (1) cathode ray tube (CRT), (2) liquid crystal display (LCD), (3) plasma display panel (PDP) and (4) projector. A comparison among these display device is shown in the following table:

| | COST | Display Area | Thickness |
|---|---|---|---|
| CRT | low | below 40 inches | large (>500 mm) |
| LCD | high | below 40 inches | small (<70 mm) |
| PDP | high | below 60 inches | small (<70 mm) |
| Projector | medium | below 60 inches | large (>350 mm) |

It apparent from the above table that none of these display devices can meet all the requirement of large display area, high luminance, low thickness and low cost at the same time.

FIG. 1 of the attached drawings shows an example of a CRT display. When the size of the display screen 8 becomes larger and larger, the size of the end part of CRT 5 needs to get larger, too. Due to the limitations of physics and technique, the distance between the CRT end part 5 and the display screen 8 can only be reduced to a certain value. When the size of the display screen 8 gets larger and larger, the distance also becomes larger. Hence, the entire size and weight of the CRT display are increased.

Therefore, in order to overcome the above defects, there is a need to develop a new display method and device to satisfy the above mentioned requirement.

### SUMMARY OF THE INVENTION

A primary object of the invention is to provide a display device in which optic fibers transmit light beams from light generation device to a display screen to form image pixels on the display screen.

It is another object of the present invention to provide a display device comprising linear arrays of illuminating elements as light generation device.

It is another object of the present invention to provide a display device comprising a multi-face rotary reflector and a light collector for changing travel path of light.

It is another object of the present invention to provide a display device capable of increasing display area thereof.

Yet a further object of the present invention to provide a method for operating the display device of the present invention.

According to the above mentioned objects, the invention provides a fiber optic display device comprising a linear array of illuminating elements, such as ultraviolet light emitting diodes, selectively emitting and projecting a first light onto a reflective surface of a rotary scanner which is rotated by a motor to have the reflective surface move the projected light over a light receiving surface of a light collector. The light collector receives the projected light and transmits the light through an array of optic fibers to a screen panel. The light is converted by a fluorescent layer of the screen panel into a visible light and forms an image.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a sketch view of a conventional CRT display device;

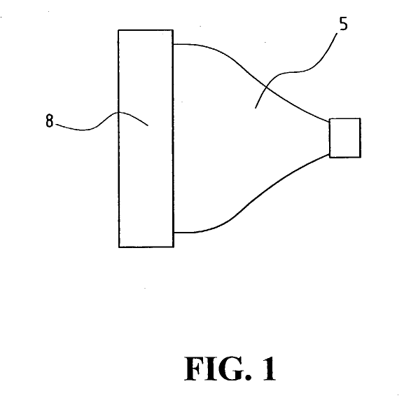

FIG. 2 is an exploded view of a display device constructed in accordance with the present invention;

FIG. 3 is a partial view of a light collector of the display device of the present invention;

FIG. 4 is a sketch view of a display panel of the display device of the present invention;

FIG. 5 is a sketch view of a magnifying device of the display device of the present invention; and

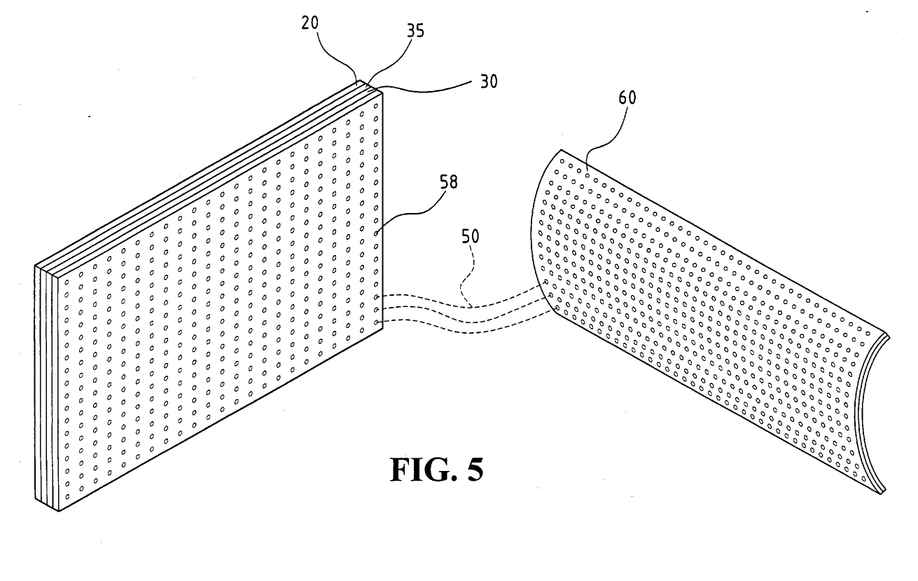

FIG. 6 is a sketch view of a rotary reflector of the display device of the present invention.

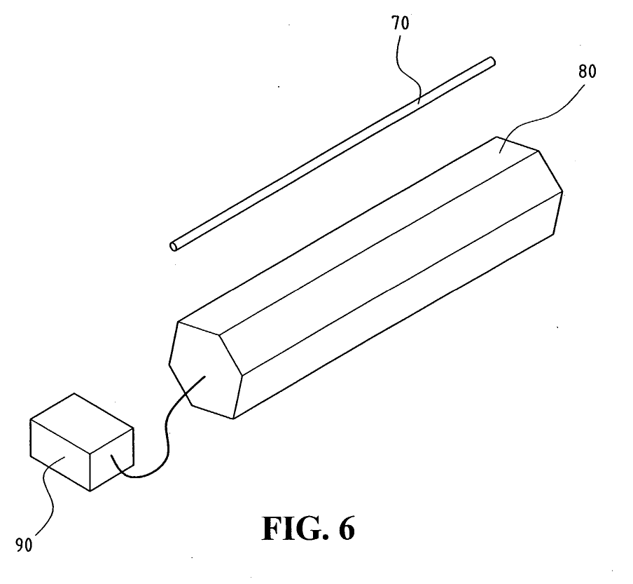

### DETAILED DESCRIPTION OF THE INVENTION

Some embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

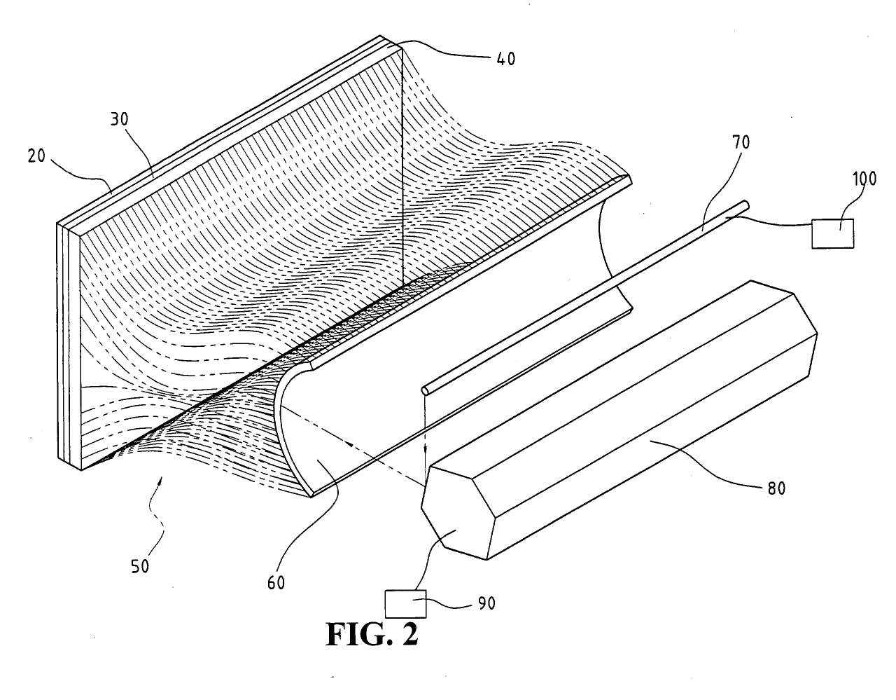

As shown in FIG. 2, a display device in accordance with the present invention comprises a linear array of illuminating elements 70, such as ultraviolet light emitting diode (UV LED), UV laser diode, blue light LED and blue light laser diode, purple light LED and purple light laser diode. In the embodiment illustrated, the linear array 70 is comprised of 3072 UV LEDs arranged in a line.

A circuit 100 controls switching of the illuminating elements 70 of the linear arrays 70 whereby light is selectively emitted from the illuminating elements 70. A multi-face rotary reflector/scanner 80 reflects and scans the light from the linear array 70 throughout a plane whereby a “planar light source” can thus be formed. The “planar light” formed by the rotation of the reflector/scanner 80 is incident onto a light collector 60. Each of the faces of the reflector/scanner 80 is capable to reflect the light from the illuminating elements 70. The reflector/scanner 80 is driven in such a way that the light reflected by a particular face of the reflector/scanner 80 is moved with the rotation of the reflector/scanner 80, thereby forming the planar light source. In the embodiment illustrated, the rotary reflector/scanner 80 is embodied as an octagonal shape having eight reflective faces. Each reflective face moves the projected light through the plane of the planer light source when the reflector/scanner 80 is rotated. Thus, the reflector/scanner 80 can scan through a whole screen per ⅛ revolution. It is apparent that the reflector/scanner 80 can be embodied in different forms. For example, the reflector/scanner 80 may comprise a triangular body, a quadrangular body, up to having twenty faces. The faces may be flat, such as planar mirror or alternatively, the faces are curved. Moreover, the reflector/scanner 80 may have an axial length greater than, equal to or smaller than a length of the linear arrays of the illuminating elements 70.

The reflector/scanner 80 is driven by a motor 90 to move the projected light to form the planar light source. In the embodiment illustrated, the rotation speed of the reflector/scanner 80 driven by the motor 90 is ⅛ revolutions each unit time, such as a second, which corresponds to 7.5 revolutions per minute, namely 450 rpm. The motor 90 can be any suitable rotation driving device, such as step motor and servo motor.

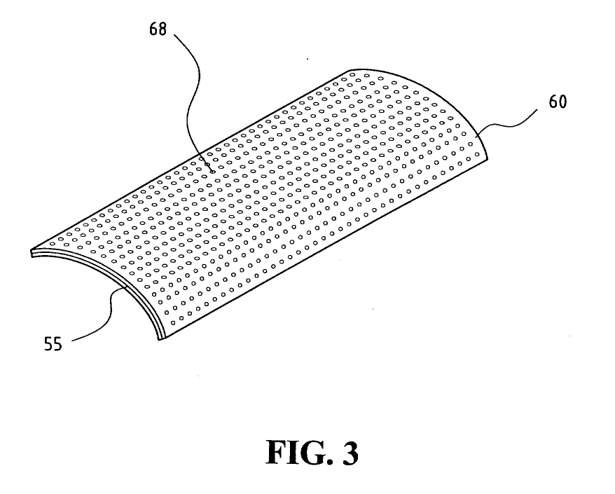

The light reflected by the reflector/scanner 80 is incident onto and received by the light collector 60 which comprises a concave surface facing the reflector/scanner 80. Thus, the projected light that is moved by the rotation of the reflector/scanner 80 scans through the concave surface of the light collector 80 that is formed by a light collecting layer 55. The light collecting layer 55 receives the light projected thereon and transmits the light received to an optic fiber array comprised of a number of optic fibers 50. A plurality of fiber connection junctions 68 (see FIG. 3) are formed on an opposite side of the light collector 60 and arranged in an array corresponding to the optic fiber array. Each fiber connecting junction 68 is connected with one of the optic fibers 50, as shown in FIG. 3. The light that is received by the light collecting layer 55 is thus transmitted to the corresponding optic fiber 50. The movement of the light caused by the rotation of the reflector/scanner 80 makes the light scanning through the light collector 60 and induces an optic signal on each optic fiber 50.

The optic fibers 50 are also connected to a screen panel 40 and forms connection junctions 58 with the screen panel 40. Each connection junction 58 or 68 may connect with one or more optic fibers 50. The light that is incident onto the light collector 60 induces optic signal in and traveling through the optic fibers 50. Eventually, the optic signals are transmitted to the screen panel 40 by the optic fibers 50 connected between the light collector 60 and the screen panel 40. The screen panel 40 converts the light transmitted through the optic fibers 50, which in the embodiment illustrated, is ultraviolet light, into visible light. This is done by a fluorescent layer 30 coated on the screen panel 40. The visible light is dispersed generally by a micro lens 35, and is further uniformly distributed by a diffuser layer 20.

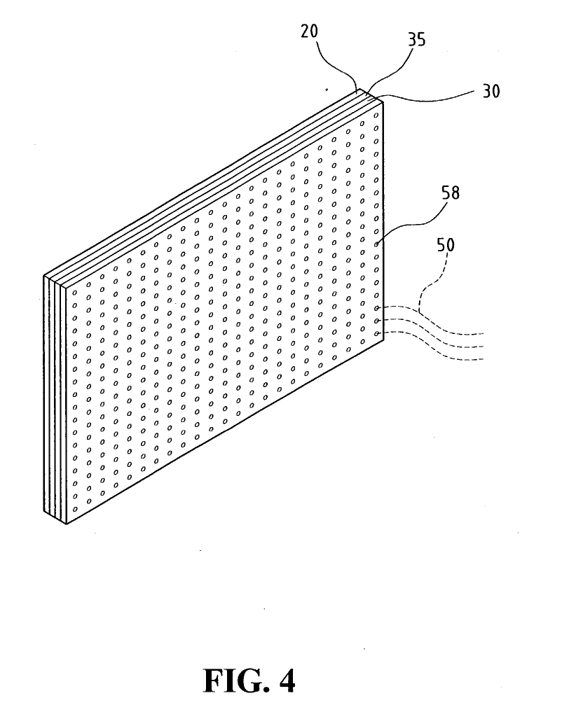

FIG. 4 particularly shows the structure of the screen panel 40 which comprises the fluorescent layer 30, the micro lenses 35 and the diffuser layer 20 stacked in sequence. Light transmitted through the optic fibers 50 is received through the junctions 58 and is converted into visible light to be distributed by the micro lenses 35 and the diffuser 20.

The optic fibers 50 that connect the light collector 60 and the screen panel 40 allows light to be projected from a small area of the light collector 60 onto a large area of the screen panel, which leads to a magnification of the image formed by the optic signal transmitted through the optic fibers. Since the image is magnified by means of optic fibers 50 that project the optic signals from a small area to a large area, screen distortion or flexion that is conventionally observed in a CRT display or a projector is completely eliminated.

Optic characteristics of the optic fibers 50 that allow for total reflection inside the fibers 50 effectively enhances the brightness of the light shown in the screen panel 40. Deterioration of light caused by being transmitted through light carrying media is thus reduced. In addition, since the optic signals are transmitted by optic fibers that are flexible, the distance between the screen panel and the light collector (as well as the illuminating elements) can be substantially shortened without causing undesired adverse influence on the performance of the display. The thickness of the resulting display can be as small as 100 mm.

Since light is transmitted through optic fibers for being projected onto a large surface area, rather than directly transmitting through a liquid crystal panel, the concern for yield rate of liquid crystal panel can be completely overcome. In accordance with the present invention, a large-sized display having a display area corresponding to a projector type display and a PDP can be easily manufactured. The size of the present inventive display can be as large as 20-200 inches.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A display panel comprising:
a plurality of fiber optic connecting junctions arranged in an array adapted to connect to a plurality of optic fibers, respectively, and receiving optic signal transmitted through the optic fibers; and
a fluorescent layer coated on the display panel to receive the optic signal and convert the optic signal into a visible light.

2. The display panel according to claim 1, wherein each fiber optic connection junction is connected with a single fiber.

3. The display panel according to claim 1, wherein each fiber optic connection junction is connected with a plurality of optic fibers.

4. The display panel according to claim 1 further comprising a micro lens for dispersing the visible light.

5. The display panel according to claim 4 further comprising a diffusing layer for uniformly distributing the visible light.

6. An image magnification device for a display adapted to project light from a small area to a large area, comprising:
a light collector having a small area, the light collector comprising a plurality of first fiber optic connection junctions arranged in a first array, the light collector adapted to receive optic signals that form an image from a signal generator;
a screen panel having a large area, the screen panel having a plurality of second fiber optic connection junctions arranged in a second array; and
a plurality of optic fibers having first ends connected to the first optic fiber connection junctions and opposite second ends connected to the second optic fiber connection junctions;
wherein the optic signals are transmitted by the optic fibers from the small area of the light collector to the large area of the screen panel for magnification of an image formed by the optic signals.

7. The image magnification device according to claim 6, wherein the light collector comprises a concave image receiving surface for receiving the optic signals from the image generator.

8. A display device comprising:
a linear array of illuminating elements, each selectively emitting a first light;
a rotary scanner having at least one reflective surface onto which the first light from the illuminating elements is incident, the reflective surface reflecting the first light and the rotary scanner being rotatable to move and scan the projected light through a plane; and
an image forming device which receives the first light from the rotary scanner, projects the light onto a screen panel which converts the first light onto a visible second light forming an image on the screen.

9. The display device according to claim 8 further comprising a circuit connected to the illuminating elements for selectively switching the illuminating elements on and off.

10. The display device according to claim 8, wherein the rotary scanner has at least one reflective surface for reflecting the first light toward the image forming device, the rotary scanner being rotatable to scan the projected light over a light receiving surface of the image forming device.

11. The display device according to claim 8, wherein the reflective surface comprises a planar reflective surface.

12. The display device according to claim 8, wherein the reflective surface comprises a curved reflective surface.

13. The display device according to claim 8, wherein the image forming device comprises a light collector which receives the first light from the rotary scanner and transmits the first light to the screen panel of the image forming device and a fluorescent layer coated on the screen panel to convert the first light into the visible second light.

14. The display device according to claim 13, wherein the screen panel has a plurality of screen side fiber optic connection junctions arranged in an array, the connection junctions being connected to optic fibers through which the first light is transmitted.

15. The display device according to claim 13, wherein the light collector has a plurality of collector side fiber optic connection junctions arranged in an array, the connection junctions being connected to optic fibers to transmit the first light through the optic fibers.

16. The display device according to claim 15, wherein each fiber optic connection junction is connected with a single fiber.

17. The display device according to claim 15, wherein each fiber optic connection junction is connected with a plurality of optic fibers.

18. The display device according to claim 15, wherein the light collector comprises a concave image receiving surface for receiving the first light from the illuminating elements.

19. The display device according to claim 13, wherein the screen panel further comprises a micro lens.

20. The display device according to claim 19, wherein the screen panel further comprises a diffusing layer for uniformly distributing the visible light.
